(19) United States
(12) Patent Application Publication
(10) Pub. No.: US 2009/0187563 A1
(43) Pub. Date: Jul. 23, 2009

(54) Methods for Generating and Indicating a Time Relevant Status for an Operating Entity

(75) Inventor: Joseph Chen, Union City, CA (US)

Correspondence Address: Venture Pacific Law, PC, 5201 Great America Parkway, Suite 270, Santa Clara, CA, 95054, US

(73) Assignee: GEOSPOT, INC., Fremont, CA (US)

(21) Appl. No.: 12/358,240

(22) Filed: Jan. 22, 2009

Related U.S. Application Data
(60) Provisional application No. 61/022,788, filed on Jan. 22, 2008.

(51) Int. Cl. G06F 17/30

(52) U.S. Cl. 707/5; 707/E17.017

(57) ABSTRACT

A method for generating an operating status at a defined time for an operating entity, comprising the steps of: generating one or more time rules for hours of operation of the operating entity; determining an operating status value by comparing the time with the time rules; and matching an operating status to said operating status value.

### CROSS REFERENCE

This application claims priority from a provisional patent application entitled “Methods for Storing Information for High Performance and High Volume Searching with Time Relevance” filed on Jan. 22, 2008 and having an Application No. 61/022,788. Said application is incorporated herein by reference.

### FIELD OF INVENTION

This invention relates to methods for generating a time relevant status for an operating entity (e.g. businesses and restaurants), and, in particular to, methods for generating and indicating a time relevant status for the operating entity based on the operating hours of the operating entity.

### BACKGROUND

The Internet offers users a variety of searchable databases that maintain a variety of data and information. For example, databases containing indexed and categorized business listings, such as a business directory. In the physical realm, this business directory is generally referred to as, for example, the “Yellow Pages”. Typically, Internet-based “Yellow Pages” take the form of a computing application providing, among a variety of other functions, the ability to search vast amounts of business demographic information. The search component of this application allows users to pair down their search by a number of search qualifiers, such as, business name, business type, and geographic location (of either the business or of the user).

As such these business directories often leave a user to navigate through volumes of unhelpful business results, rendering their initial search almost futile. In addition, current business directory search engines have complicated and cumbersome user interfaces that require the user to input a significant amount of preference information before performing the search. Furthermore, these directories are limited to business listings, and do not offer the versatility to search for other operating entities including parks, golf clubs, tennis clubs, roads, hiking trails, fixtures, moving objects (e.g. buses, taxis, and people), buildings, public bathrooms, trash cans, bus signs, mail drop off boxes, concerts, events (e.g. open houses, happy hours, birthday parties, and so forth), and other things.

A few generalized search engines can use business directories to provide for the display of certain characteristics, including the hours of operations of a business. However, these engines cannot pull results for businesses based on other characteristics, such as whether the business is dog-friendly, the forms of payment that a business accepts, whether the business is open at certain hours, and other characteristics.

In an effort to meet consumers' demand for finding and displaying more relevant information, Internet search sites can display operating hours for operating entities; some can even interpret those hours by listing what is currently opened for a defined time. For instance, the operating hours of a business can be displayed and interpreted in the following manner, “Mon-Fri 9 am-9 pm, and Sat-Sun 10 am-6 pm”. These are simply weekly recurrence rules for the time of day that a business is opened.

Existing prior art methods provide calendaring functions for the purpose of a single or a group of user displays and user alerts. However, they do not serve the purpose for searching for operating entities; nor provide specially designed encoded data structures and rule matching functions to satisfy typical queries, such as seeking effective operating times for businesses, events, and products at a future, present, or past time and at various geographical locations.

Existing prior art methods are of two general types: (1) using calendar applications on personal computers or web applications with back office servers; and (2) displaying operating hours on a webpage in simple text. This text is stored and displayed for humans to interpret, but is very difficult for computers to use for matching user queries. Recently, there have been simple attempts for matching recurring time, such as 9 am-9 pm. However, these attempts are not capable of more sophisticated forms of expressions and computer interpretation. The display of the hours of operation for an entity in simple text is an ineffective method for conveying operating hours to users who want to quickly ascertain what is currently opened.

Also, the existing prior art methods lack the ability to delve deeper into a business listing and convey meaningful information. For instance, existing prior arts do not base the status of an operating entity on the various subservices offered by the operating entity. A subservice may be a service, a department, or other entities within an operating entity. For instance, a retailer (e.g. Costco) may have various subservices within its retail store, including a pharmacy, an automobile tire center, a food court, a photo service department, a gas station, and other departments. These various subservices may have different operating hours, which are not meaningfully conveyed by the existing prior art methods.

Therefore, it is desirable to provide methods that are capable of efficiently providing more relevant and useful content to users.

### SUMMARY OF INVENTION

An object of this invention is to provide methods for generating an operating status for an operating entity based on the operating hours of the entity and the operating hours of each subservice of the entity.

Another object of this invention is to provide methods for generating operating hour rules (also referred to as time rules) and exceptions for an operating entity, wherein date and time substitutions can be used.

Yet another object of this invention is to provide the capability to define multiple sets of time rules for an operating entity, where one set of time rules can be temporarily overridden for a period of time by another set of time rules.

Briefly, the present invention relates to methods for generating an operating status at a defined time for an operating entity, comprising the steps of: generating one or more time rules for hours of operation of said operating entity; determining an operating status value by comparing said time with said time rules; and matching an operating status to said operating status value.

An advantage of this invention is that methods for generating an operating status for an operating entity based on the operating hours of the entity and the operating hours of each subservice of the entity are provided.

Another advantage of this invention is that methods for generating operating hour rules and exceptions for an operating entity, wherein date and time substitutions can be used, are provided.

Yet another advantage of this invention is that multiple sets of time rules for an operating entity can be defined, where one set of time rules can be temporarily overridden for a period of time by another set of time rules.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates a result of displaying an operating status for several operating entities on a webpage.

FIG. 2 illustrates a process flow for generating an operating status for an operating entity at a particular time or at a particular time range.

FIG. 3 illustrates an operating entity data model for storing an operating entity's information.

FIG. 4 illustrates a process flow for generating an operating status for an operating entity based on the operating hours of an operating entity and based on a defined time.

FIG. 5 illustrates a result of displaying a webpage that indicates operating statuses for a Chevron station and its subservices using a preferred embodiment of this invention.

### DETAILED DESCRIPTION OF THE PREFERRED EMBODIMENTS

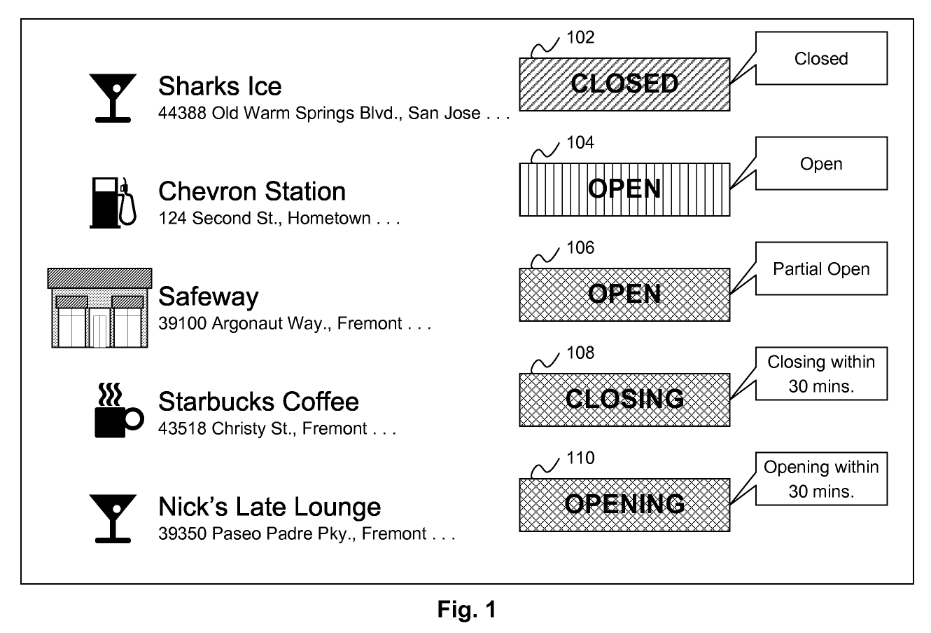

FIG. 1 illustrates a display (e.g. a web page) of the operating statuses for several operating entities that may be generated by the preferred embodiment of the present invention. An operating entity herein may also be referred to as an entity. There may be five operating statuses: open, closed, opening, closing, and partial open. An operating status can be displayed in various colors and with various backgrounds to allow a user to quickly identify an operating status. For example, a traffic light color scheme may be used to display the operating status for an operating entity. The operating status for each operating entity can be displayed adjacent to a list of operating entities. The operating status can indicate whether an operating entity is open, closed, opening (or about to open), closing (or about to close), or partial open (if only certain subservices are open at the defined time). This defined time can be specified by a user, an entity, a requester of the status for an entity, a default setting, or other entities. An example of a default setting would be where a defined time is set to the current local time when the operating status is generated.

A closed operating status may be displayed in a box 102 having a red fill and white text displaying “CLOSED.” The closed operating status indicates that Shark's Ice is closed at the defined time (e.g. a user specified time or a current local time). The open operating status may be displayed in a box 104 having a green fill and a yellowish text displaying “OPEN.” The open operating status indicates that the Chevron Station is opened at the defined time. Similarly, partial open (also referred to as fuzzy open), closing, and opening statuses can be displayed in boxes, 106, 108, and 110, respectively, having a yellow fill and black text to display the respective status. The partial operating status indicates that certain subservices in Safeway are open, while other subservices are closed. The closing operating status indicates that Starbucks Coffee will be closing in a predefined amount of time from the defined time, where in this case the amount of time is 30 minutes. The opening operating status indicates that Nick's Late Lounge will be opening in a predefined amount of time from the defined time, where in this case that amount is 30 minutes.

The traffic light color scheme can significantly add meaning to a list of search results since the user can simply browse for a specific color to quickly ascertain the operating status for an operating entity, instead of having to read the details for each operating entity. Additionally, if the user wants to find out more details about an operating entity, the user can select that entity from the listing to display the full details of that operating entity.

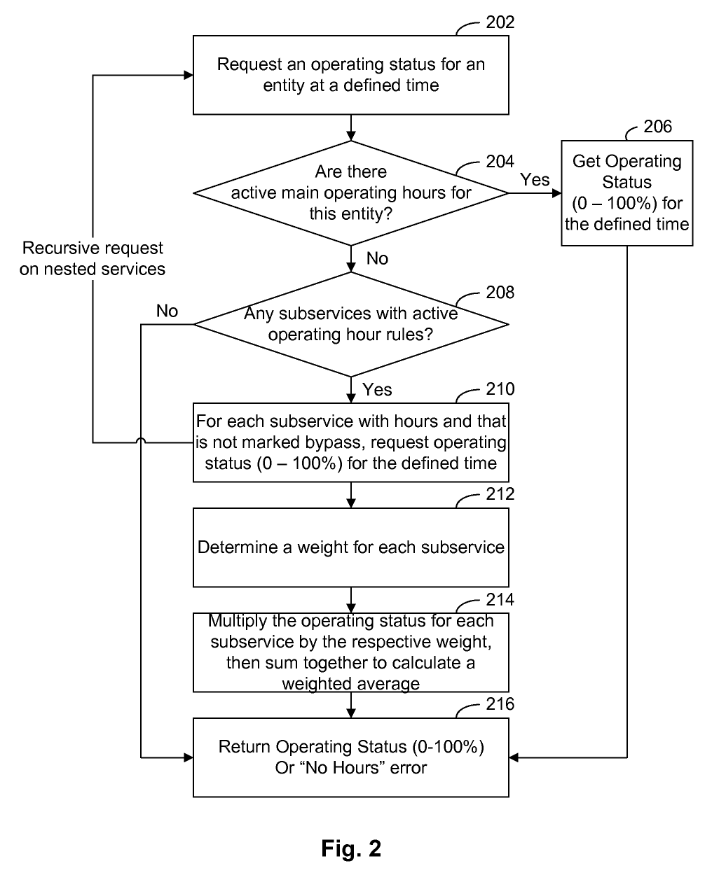

FIG. 2 illustrates a process flow for generating an operating status for an operating entity at a particular time or at a particular time range. First, a request is made for an operating status for an entity for a defined time 202. This request can be generated by a search engine to find results matching a particular set of search criteria by a user, or the user can directly input a name of an operating entity and a particular time to generate an operating status for that operating entity.

The request can be made via a network (e.g. Internet) from a user device (e.g. mobile phone, computer, and PDA) to a content provider for this information. Additionally, the user device may store this information in the user device's memory (e.g. its own hard disk drive or flash memory), thereby not needing to request this information from a content provider. For instance, if the user device is a global positioning system (GPS) unit, then the GPS can query its memory for a listing of operating entities. The information for an operating entity such as its address, hours of operation, services, and other information can be efficiently stored in a data model.

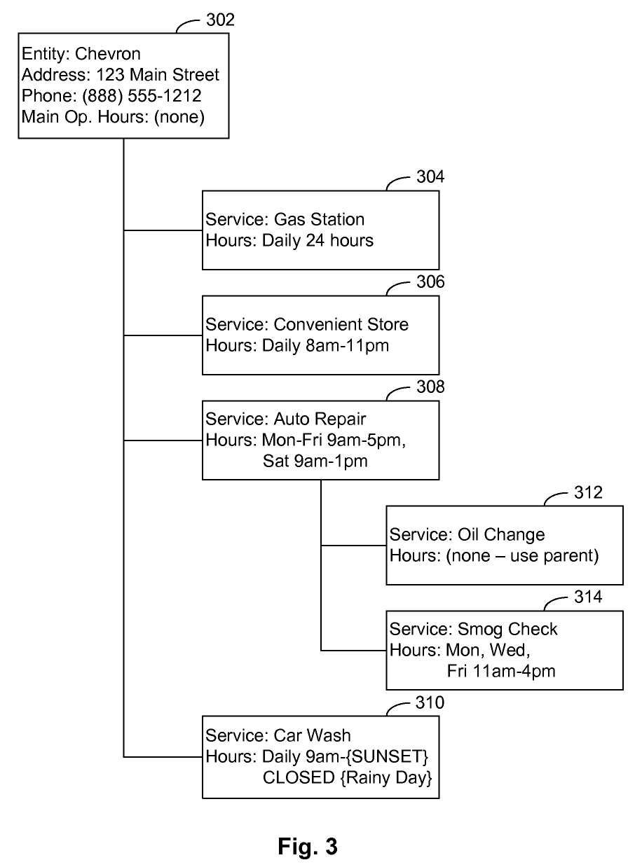

FIG. 3 illustrates an operating entity data model for storing an operating entity's information. This data model can be implemented by a general programming language (e.g. c++, java, and XML). The data model illustrates an operating entity (e.g. a Chevron gas station), which has a root level definition 302. On this root level definition 302, the name of the entity, the address of the entity, the phone number of the entity, and the main operating hours of the main entity can be found. For every subservice provided by this business, there can be a child-level definition. Here, there is a gas station definition 304, a convenient store definition 306, an auto repair definition 308, and a car wash definition 310. With respect to each child-level definition, each definition may contain the hours of operation for that corresponding subservice. For instance, the gas station definition is open everyday for 24 hours a day. The child level definition can have its own children. For instance, the auto repair service has an oil change subservice 312 and a smog subservice 314. The definition for these subservices, 312 and 314, respectively, are nested under the auto repair definition 308 (its parent definition).

Referring back to FIG. 2, once a request is made for an operating entity's information, that information is retrieved and then checked for whether there are active main operating hours for this entity 204. Note that this can be a recursive function, where this “entity” could be a sub-entity to a higher level entity. It is important to note that operating hours can apply to events, products, fixtures, and other operating entities as well as to restaurants, retailers, and other businesses.

If there are active main operating hours, the operating status at a defined time is determined 206. The operating status is determined by comparing the operating hour definition (also referred to as a time rule) for the operating entity and the defined time, or the defined range in time, to find a percent of the operating entity that is opened at that point time.

If the operating status value is 0% (i.e. the operating entity is closed), then a time-to-opening value will be returned as well as the operating status value. The time-to-opening measures the amount of time from the defined time, t, to when the entity is to be opened (i.e. when the operating status is open or partial open). If the operating status is open or partial open, then a time-to closing value can be generated along with the operating status value. This time to closing measures the amount of time from the defined time to when the operative entity will be closed or when any nested subservices will be closed. A user or individual business can define whether a time-to-opening value or a time-to-closing value will be displayed to the user.

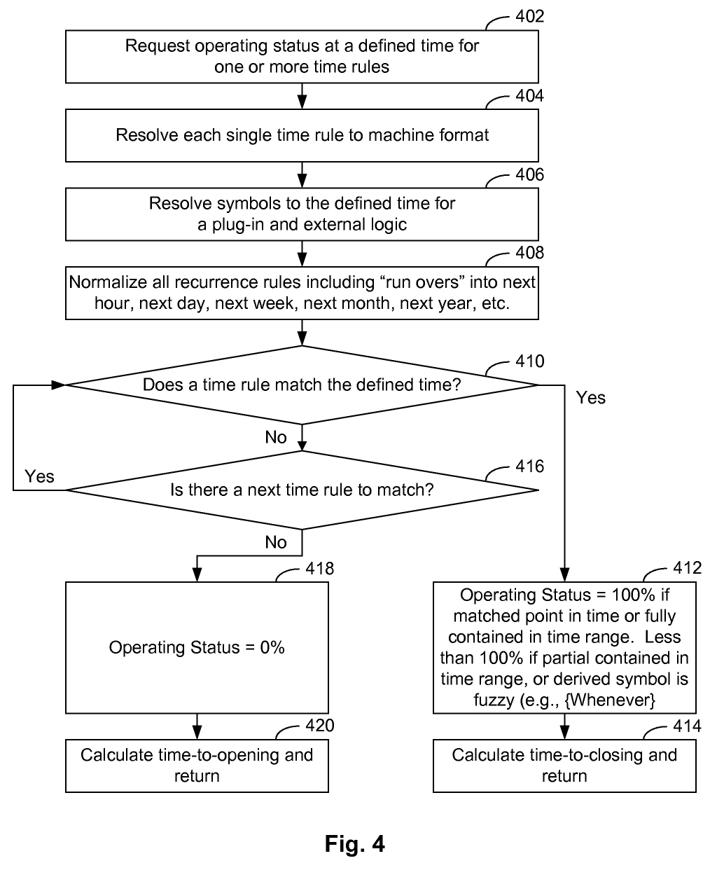

In another embodiment of this invention, it is determined whether the time-to-opening value is within a preset time range, where displaying the operating status of opening is worthwhile. Similarly, if a business has an open or a partial open operating status, but the time-to-closing value is within a present amount of time, the operating status of closing can be displayed. More details for generating an operating status value are explained later in FIG. 4.

Referring to FIG. 2, the operating status and either a time-to-closing value or a time-to-opening value can be returned to the user 216.

If active main operating hours do not exist for this entity 204, then determine whether any subservices with active operating hours are present for this entity 208. If the subservices do not have active operating hours, then return a “No hours” error message to the user 216. For this case, the operating entity does not have active operating hours for its main entity or its subservices, therefore a “No hours” error message is returned to the user.

If one or more subservices have active operating hours, then determine the operating status for each subservice that has not been previously marked to be bypassed 210. An operating entity can identify one or more services that must not be included in the overall operating status calculation. An operating status value can then be determined for these subservices in a similar manner as in step 206. Additionally, a time-to-closing and a time-to-opening are found for each subservice. More details for generating an operating status value are given in FIG. 3.

If a subservice has one or more sub-subservices (e.g. its own subservices), then determine the overall operating status for the subservice at the defined time by finding a weighted average of the operating statuses for the one or more sub-subservices.

After the operating status value for each of the subservices is determined, a weighted average is applied to find the overall operating status of the entity. First, a custom weight can be determined for each subservice to weight the respective subservice for the weighted average calculation. This weight can be predefined by the entity, the user, or by assessing the respective subservice's importance to the overall status of an entity. If a custom weight is not assigned for the subservices, the subservices can be weighed equally 212.

The determined weight for a subservice can be multiplied to its respective subservice 214. These values are then summed together to generate the operating status of the entity. This operating status of the entity is returned 216. The value of the operating status can be returned to the user to indicate the percentage of the entity that is open at the defined time. If the operating status of the entity is closed, then the time-to-opening value can be returned to the user to indicate the amount of time from the defined time to when the entity is opened (i.e. when the entity has an open status or a partial open status). Additionally, if the operating status is open or partial open, then a time-to-closing can be returned to the user to indicate the amount of time from the defined time to when the entity is closed (i.e. the entity has a closed status).

The returned operating status value can be from 0% (i.e. closed) to 100% (i.e. open). In the preferred embodiment, the range from 1% to 69% can be defined as a partial open, and 70% to 100% can be considered fully open. The threshold between partial open and open can be individually specified for each operating entity (and its individual subservices) and can be any percentage. Similarly, the range of partial open can be changed to any range between 0% and 100% operating status. Furthermore, the operating status value can be displayed in percentage form or can be displayed using the five operating status identifiers of open, closed, opening, closing, and partial open as illustrated in FIG. 1.

Note, any subservice with operating hours that is flagged or otherwise deemed inappropriate to include in calculating the operating status for the operating entity can be bypassed. These inappropriate subservices can be specified with a 0% weight factor or explicitly flagged for bypass during the operating status calculation.

FIG. 4 illustrates a process flow for generating an operating status for an operating entity based on time rules for that entity and a defined time. The operating status is determined by requesting an operating hours' definition (e.g. time rules) for the entity and a point in time (or a range in time) 402. The operating hours' definition is resolved into one or more single time rules 404.

Each time rule can be expressed in a machine format for efficient processing. A time rule can be used to efficiently denote the operating hours of an entity, and can also be used to denote the exceptions to these operating hours.

Furthermore, the entity may override a time rule with temporary time rules. An owner of an operating entity can select among a set of operating hours' definitions that are not active, and activate one to override a currently active one for a specified amount of time. For example, a retail business operates with regular hours from 9 am to 5 pm, 7 days a week. The owner during holiday season can specify special hours from 9 am to midnight for December 01st to December 23^{rd} to accommodate for the Christmas shopping season.

A time rule can be denoted by: Mon-Fri 10 am-9 pm; Sat-Sun 9 am-6 pm; Daily 24 hrs; 3rd Sunday of every month; {Dawn} to {Dusk}; 5 pm to {Whenever}; or Closed {Labor Day Weekend}. Table 1 illustrates various encoding rules and the corresponding text for those encoding rules. Encoding symbol “T” can represent the time of day in terms of seconds from a reference point. For instance, T36000 represents 36,000 seconds from midnight (i.e. 10 am), where midnight is the reference point for this example. A range of times can also be represented by T36000-39600, which corresponds to 10 am (i.e. 36,000 seconds from midnight) to 11 am (i.e. 39,600 seconds from midnight). Additionally, an encoding symbol, “*”, can be used to represent any number (also referred to as a wildcard). For instance, “T*” can represent a range of 24 hours.

An encoding symbol, “D”, can represent the day of the week. A value adjacent to the symbol “D” can signify a specific day of the week, where this value can range from 0 to 6, inclusively, and where each value corresponds to a specific day of the week. For instance, “D0” can correspond to Sunday; “D1” can correspond to Monday; “D2” can correspond to Tuesday; and so forth. A range of days can be denoted by the symbol “D” and a range of values after “D”. For instance, “D1-3” can denote Monday to Wednesday.

Furthermore, various symbols can be combined to generate rules for operating hours on a weekly basis. For instance, “T*:D1-5” can denote Monday through Friday, 24 hours a day. An encoding symbol of “:” can be used to separate various encoding symbols. Also, other encoding symbols can be used to represent a date and time. For instance, “m” represents a month; “C” with a number adjacent to the number denotes a specific day of a month; “R” denotes a rule, whereby placing a number next to “R” (e.g. “R1” denotes rule 1; “R2” denotes rule 2; and so forth); “+” or “−” symbol in front of a rule symbol “R” can be used to denote whether that rule is a general rule, or an exception to the general rule; and other symbols can be used to represent a date and/or a time of day.

These encoding symbols can be used in conjunction with each other. For instance, the encoding symbols, “+R1:m” and “−R2:C5”, can be used denote that the general rule, “+R1” covers every day of a month “m”, except for the exception of the rule, “−R2”, which is the 5th day of every month, “C5”. Table 1 illustrates more examples and explanations for efficiently encoding symbols to a machine readable format. However, this table is not exhaustive and is merely an exemplary embodiment of our invention. It is to be appreciated that a person having ordinary skill in the art would be able to expand upon this table of encoding symbols.

In addition to the encoding symbols, plug-in symbols can be included in rules to account for variable dates that do not lend themselves to a particular day and/or particular calculation. For instance, the encoding rule, “T3600-{DUSK}” can be denoted to mean 10 am to dusk. Since dusk is not constant for everyday of the year and is dependent on the geographical location of the entity, the time for dusk cannot be set definitively in relation to midnight. Therefore, the dusk symbol, “{DUSK}” can be updated by a plug-in code to execute that calculation of dusk for a particular time zone, season, and geographic area. Table 2 illustrates other plug-in symbols, where these derived symbols can be used to connect to external logic to provide specific dates and/or times. It is to be appreciated that a person having ordinary skill in the art would be able to expand upon this table of plug-in symbols.

For each single time rule, resolve symbols to a point in time or a time range for a plug-in and external logic 406. All recurrence rules are normalized including rules that run over into a next hour, next day, next week, next month, next year, and so forth 408. A first time rule is compared to the defined time, where the defined time can be a specific time or range of times. If the defined time is a specific time, the first rule is compared to the defined time to determine whether the defined time is within the range of operating hours described by the time rule 410. If so, then a 100% operating status is returned.

If the defined time is a range of time, the time rule is checked as to whether the defined time completely overlaps the time rule. If it does, a 100 percent operating status is returned 412. Otherwise, the percentage of the overlap between the defined time and the time rule is returned 412.

Additionally, the time-to-closing value is calculated and returned 414. The time-to-closing value is determined by calculating the difference between the defined time and the next closing time for the operating hours' definition.

If the first time rule does not overlap with the defined time, then determine if there is a next time rule 416. If so, then use this next time rule to check whether the defined time overlaps with this time rule. If not, then define the operating status as 0% (i.e. closed) and return this value 418.

Additionally, a time-to-opening is calculated and returned 420. Time-to-open value is calculated by calculating the difference between the defined time and the next earliest operating hours of the entity. This value can be in terms of seconds, minutes, days, years, or in any other units of time.

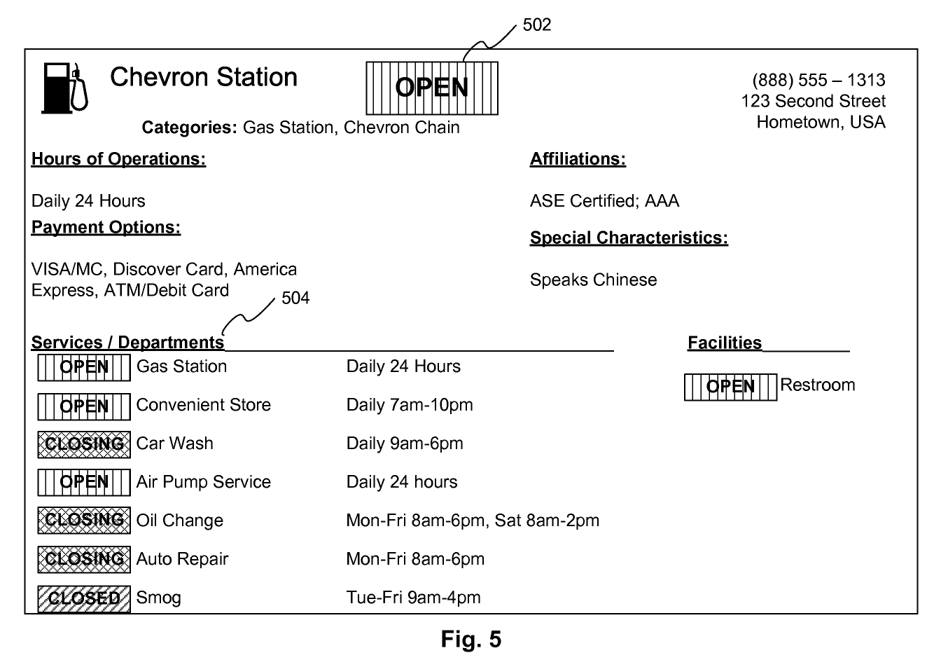

FIG. 5 illustrates a webpage that indicates operating statuses for a Chevron station and its subservices using a preferred embodiment of this invention. An operating entity can be a simple business with a single operating hour definition. However, modern operating entities can offer multiple subservices, where each service may have various operating times. For instance, this Chevron station offers various services including a gas station, a convenient store, a car wash, an air pump service, an oil change service, an auto repair service, and a Smog check service. The hours of operation for each of these services can be different from the main business' operating hours and different from one another. Therefore, a method is needed to identify the overall operating status at a particular time and day for this Chevron station.

The determination of the overall operating status will entail analyzing the availability of each service (or subservice) with its own operating hours. For instance, at various times of the day, some services are closed why other services are open. Table 3 states examples of various operating statuses for a designated time of day using a preferred embodiment of this invention. The notes column of Table 3 states which services are open and which are closed.

First, the Chevron station's information (i.e. the operating entity's information) is retrieved. If a time of day to compute an overall status is for “NOW”, then a current time is used. If the determination of the operating status is for a desired time, other than a current time, (e.g. a time in the future or past), the desired time will be used to match against the time rules for the Chevron station. Furthermore, a search engine can filter search results for operating entities based on the operating statuses for the operating entities at a defined time by only displaying what is opened (i.e. with an open operating status) at the defined time. For instance, a search engine can filter search results by only displaying entities that are opened at a defined time, such as on last Sunday, anytime, now, after 10 pm, after sunset, 24 hrs a day, this Saturday 10 pm-2 am, next Saturday after 9 pm, Christmas day, Christmas 2012, first Tuesday of every month, or any other time.

There can be more than one set of operating hours defined, but only one can be active for processing. The returned operating status value can be from 0% to 100% open, and, if need be, a time-to-opening or a time-to-closing value. A 0% operating status value can mean that the station is closed during the desired time. By default, an operating status value from 1% to 69% can be a partial open operating status, and an operating status value from 70% to 100% can be considered that the Chevron station has an operating status of open. The threshold of 70% between a partial open and an open operating status can be changed according to the user specified criteria, based on an entire category of operating entities (e.g. all gas stations), or based on the operating entity itself.

If main operating hours are not defined, then proceed with rolling up from the 7 subservices having operating hours. The subservices without operating hours defined will be skipped and not weighed in the final determination of the overall operating status. If there are no special weights assigned to each service that may tilt the percentage, each service will be weighted equally at 14.29% (e.g. 100%/7 services). Weights can be assigned to a subservice depending on the importance of that subservice to its respective operating entity. For instance, the gas station service may have the most importance, thereby having a weight of 45% assigned to it; whereas, the air pump service may have very low importance, thereby having a weight of 0.5% or altogether bypassed in the calculation for the operating status of the entity.

For each of the 7 subservices with operating hours attached, an operating status value from 0% to 100% is calculated. If a subservice has nested services within that subservice, then nest into those services to tabulate an overall operating status value for that subservice. This overall status value for a subservice will represent the operating status for that subservice. Once the operating statuses for each service is calculated, the weight is applied to each service and those values summed together to calculate a weighted average. In other words, the status value for each service is multiplied by 14.29%, and then summed together to find the overall status value for the station.

The overall status value can be displayed, along with the respective operating status symbols (e.g. CLOSED, PARTIAL OPEN, OPEN, CLOSING, and OPENING). The overall status of the chevron station can be displayed in box 502 on the webpage with an “OPEN” status. Furthermore, the operating statuses for the subservices can also be displayed next to the listing of the subservices 504.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

TABLE 1
Time Rule Data format

| Readable Text | Encoding Rule(s) | Notes |
|---|---|---|
| 24 hrs | T* | T = Time of Day, * = wildcard |
| Daily 24 hrs | T*:D* | D = Day of Week (0-6) |
| Mon-Wed | D1-3 | Monday thru Wednesday |
| | | with no time of day |
| Mon-Fri 24 hrs | T*:D1-5 | D1-5 means Mon + 5 days |
| Daily 10 am-8 pm | T36000-72000:D*. | T is seconds since midnight |
| Daily 10 am-DUSK | T36000-{DUSK} | {DUSK} is a symbol with |
| | | plug-in code to execute that |
| | | can be calculated based on |
| | | time zone and season. |
| Daily 10 pm-2 am | T79200-14400:D* | Range to deal with boundary |
| | | condition on midnight which |
| | | is easier to check |
| Mon-Wed, Fri | T36000-7200, T50400-7200, | One rule can specify multiple |
| 10 am-12 pm, 2 pm-4 pm, | T64800-14400:D1-3:D5 | time range in a same day |
| 6 pm-10 pm | | |
| Mon-Fri 8 am-8 pm | T28800-72000:D1-5 | Single rule for working week |
| Mon-Fri 8 am-8 pm PDT | T28800-72000:D1-5:ZPDT | Explicit time zone instead of |
| | | implicitly derived |
| Mon-Fri 11 am-5 pm, | R1: 39600-21600:D1-5 | Two rules required. Second |
| Sat-Sun 10 am-7 pm | R2: 36000-25200:D6-2 | rule wrap around Sat to Sun. |
| Mon-Fri 8 am-8 pm | T28800-72000:D1-5:W2:m | Lower case “m” is relative |
| Every second week | | month. “m2” would be |
| Monthly | | every other month. |
| Every 5^{th} Day Monthly | C5:m | |
| Monthly Except 5^{th} Day | +R1:m | Rule one covers every day of |
| | −R2: C5 | month, while rule 2 says |
| | | except for the 5^{th} day |
| Daily 24 hrs Except | +R1:T*:D* | Absolute day for exception |
| December 25th | −R2: M12:C25 | |
| Daily 24 hrs Except | +R1:T*:D* | Use symbol with plug-in |
| Thanksgiving, | −R2:{THANKSGIVING}, | logic to derive Thanksgiving |
| Christmas | {CHRISTMAS_DAY} | and Christmas |
| Sunday of 2^{nd} week of | Y2005-2010:M1:W2:D0 | |
| Jan Between 2005-2010 | | |
| Thanksgiving Weekend | Y:M11:W-1:D4-4 | Thursday + 4 days from the |
| | | last week of November |
| Memorial Weekend | {MEMORIAL_WEEKEND} | Plug-in code to do relative |
| | | annual calculation |
| Chinese New Year | D{CHINESE_NEWYEAR}-7 | Chinese New Year (Day) and |
| Week | | 7 days that follows |
| 0^{th} and 30^{th} second every | S0:S30 | S is directive for seconds |
| minute | | into minutes |
| 15^{th} and 55^{th} second | S15-5:S55-10 | 55^{th} second that last 10 |
| every minute and last 5 | | seconds will go 5 seconds |
| and 10 seconds | | into the next minute |
| respective | | |
| 25 and 55 on the hour | I25:I55 | Good to specify business |
| | | report on the news radio |
| Every 2 hours starting | H11:h2 | Large H directive is absolute, |
| from 11 am | | and small “h” is recurring |

TABLE 2
Plug-in Symbols

| Symbol | Notes |
|---|---|
| American Holidays | |
| MLK Day | Martin Luther King Holiday: third Monday |
| | of January |
| MLK Weekend | |
| President's Day | Washington's Birthday: third Monday of |
| | February |
| President Weekend | |
| Good Friday | Friday before {Easter Sunday} |
| Easter Sunday | First Sunday after . . . |
| Memorial Day | |
| Memorial Day Weekend | |
| Labor Day | |
| Labor Day Weekend | |
| Thanksgiving Day | |
| American Holidays | A collective dates declared as national holidays |
| Notables for Shopping | |
| Black Friday | |
| Cyber Monday | |
| Other Holidays | |
| Chinese New Year | |
| Ramadan Week | |
| Seasonal Range | |
| Winter | |
| Spring | |
| Summer | |
| Winter | |
| Situational Daily | |
| Dawn | Twilight before sunrise. Sun is 18 degrees |
| | below the horizon in the morning |
| Sunrise | |
| Sunset | Daily disappearance of the sun. |
| Dusk | Beginning of darkness |
| Rainy day | Tie to weather for location to determine |
| | if it's raining |
| Whenever | Usually for clubs - 5 pm to whenever. |
| | Apply fuzzy logic or indicate partial open. |

TABLE 3
Chevron station operation status at various times and days

| Time of Day | Overall Status | Notes |
|---|---|---|
| Monday 7 am | Partial OPEN | Gas Station, Convenient |
| | | Store open |
| Monday 9 am | Partial OPEN | Everything is open except |
| | | Smog |
| Tuesday 9 am | OPEN | Everything is open |
| Tuesday 5 pm | Partial OPEN | Smog closed |
| Tuesday 11 pm | Partial OPEN | Convenient Store closed |

We claim:

1. A method for generating an operating status for an operating entity at a defined time wherein said operating entity having zero or more subservices and wherein the operating entity and each of the subservices having hours of operation, comprising the steps of:
generating an operating status value for said operating entity as a function of the hours of operation of the operating entity and the subservices, wherein such operating status value is indicative of the operating status of the operating entity.

2. The method of claim 1 further comprising the step of: matching said operating status value to an operating status.

3. The method of claim 2 wherein the operating statuses include: open, opening, closed, closing, and partial open.

4. A method for generating an operating status for an operating entity at a defined time, comprising the steps of:
providing one or more time rules for hours of operation of said operating entity;
determining an operating status value by comparing the defined time with said time rules; and
matching said operating status value to an operating status.

5. The method in claim 4 wherein said operating entity having one or more services, and wherein one or more time rules are associated to one or more subservices.

6. The method in claim 5 in the determining step, comprising the steps of:
generating a status value for each of said subservices by comparing said defined time with said time rules for said associated subservice;
calculating an average value for the status values of said subservices; and
setting said average as said operating status value for said operation entity.

7. The method in claim 4 wherein said operating status value is a percentage of the time the operating entity is operational during said defined time.
